(19) United States
(12) Patent Application Publication
(10) Pub. No.: US 2007/0286245 A1
(43) Pub. Date: Dec. 13, 2007

(54) Digital signal processing apparatus and data stream processing method

(76) Inventor: Masahiro Yamada, Nishitama-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/730,101

(22) Filed: Mar. 29, 2007

(30) Foreign Application Priority Data
Mar. 31, 2006 (JP) 2006-100545

(51) Int. Cl. H04J 3/06

(52) U.S. Cl. 370/503

(57) ABSTRACT

According to one embodiment, a time stamp synchronizer rewrites a time stamp added to a TS packet of an inputted TTS into a value synchronous with PCR of the TTS to provide a synchronized TTS. First and second counters both count a clock generated by an STC oscillator. A time stamp synchronizing transfer outputs a TS packet of the synchronized TTS based on the rewritten time stamp and a count value of the firs counter. The TS packet is supplied to a video decoder and an audio decoder via a de-multiplexer, and decoded at timing based on a count value of the second counter.

### CROSS-REFERENCE TO RELATED APPLICATIONS

This application is based upon and claims the benefit of priority from Japanese Patent Application No. 2006-100545, filed Mar. 31, 2006, the entire contents of which are incorporated herein by reference.

### BACKGROUND

1. Field

One embodiment of the invention relates to a digital signal processing apparatus, which receives a data stream sent via digital broadcasting or communication network.

2. Description of the Related Art

Recently, digital satellite broadcasting such as CS and BS or terrestrial digital broadcasting has been popularized. The digital broadcasting enables user to view a vivid image on a large screen in user's home. Moreover, viewer-joined type interactive broadcasting and data broadcasting are realized. In addition to broadcasting using sound and video so far, information such as weather forecast, stock market information and various news have been digitized and broadcasted.

A transport stream (TS) obtained from receiving the digital broadcasting is decoded or recorded in a recording medium such as a hard disk drive (HDD). In this case, a time stamp generated based on a clock signal generated from an oscillator unique to a receiver is added to a TS packet of the TS. Then, the time stamp is supplied as a time stamped TS (TTS) to a decoder or HDD. The TS packet forming the TS previously includes a PCR packet having time information, that is, program clock reference (PCR) one or more per 100 mS.

Jpn. Pat. Appln. KOKAI Publication No. 2003-283996 discloses a time stamp adding apparatus. The time stamp issue apparatus adds a time stamp synchronous with PCR time information to a TS packet when receiving TS.

Recently, a digital signal processing apparatus has come into wide use in addition to digital broadcasting. The digital signal processing apparatus receives a coded stream including a video content from a server on a network via Internet or communication network such as household LAN, and then, reproduces the coded stream.

As described above, when the video content is received via the network, jitter occurs in time when each TS packet reaches the receiver depending on line congestion. In order to normally reproduce TS having the foregoing jitter on the receiver side, a time stamp is added to each TS packet in the video content obtained via the network. Then, the video content is delivered as TTS on the network.

When the received TTS is reproduced, a transfer processor in the receiver processes the TTS based on the time stamp of the TS packet, and the TTS is outputted as TS in real time. As described above, the transfer processor converts the TTS into real time TS.

In the TTS received from the foregoing network and the TTS created via a general method, the time stamp is not synchronous with PCR. When the transfer processor converts the foregoing TTS into TS in real time, each TS packet is outputted according to a count value of a counter operating by a time stamp clock independently generated by a receiver. For example, if the count value coincides with a time stamp value, the TS packet is outputted.

A de-multiplexer extracts video data and audio data from the TS outputted in real time. The video data is supplied to a vide decoder to decode it while the audio data is supplied to an audio decoder to decode it.

In decoding, PCR included in the PCR packet is extracted, and then, a clock signal, that is, system time clock (STC) synchronous with the PCR is generated. The clock signal STC is generated using a voltage control oscillator such as voltage controlled Xtal oscillator (VCXO). The decoder decodes data based on the clock signal STC. Thus, the clock signal STC is a clock signal different from the foregoing time stamp clock signal. Two clock signals are not synchronous with each other.

As described above, in order to reproduce TTS having time stamp and PCR, which are not synchronous, two clock oscillators are required. One is an oscillator (generator) generating a time stamp clock, and another is an oscillator generating a PCR clock.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a digital signal processing apparatus 100 according to a first embodiment of the present invention;

FIG. 2 is a view showing the configuration (structure) of TTS;

FIG. 3 is a view showing the structure of a TS header;

FIG. 4 is a view showing the structure of PES;

FIG. 5 is a block diagram showing the configuration of a time stamp synchronizer 12a given as a first example of a time stamp synchronizer 12 of FIG. 1;

FIG. 6 is a graph to explain the operation of the time stamp synchronizer 12a;

FIG. 7 is a view showing one example of pre-rewrite time stamp and rewritten time stamp in the time stamp of TTS;

FIG. 8 is a view showing another example of pre-rewrite time stamp and rewritten time stamp in the time stamp of TTS;

FIG. 9 is a block diagram showing the configuration of a time stamp synchronizer 12a given as a second example of a time stamp synchronizer 12 of FIG. 1; and

FIG. 10 is a block diagram showing the configuration of a digital signal processing apparatus according to a second embodiment of the present invention.

### DETAILED DESCRIPTION

Various embodiments according to the invention will be described hereinafter with reference to the accompanying drawings. In general, according to one embodiment of the present invention, there is provided a digital signal processing apparatus comprising: an input unit configured to input a TTS having a time stamp added to a TS of a digital signal from the outside; a time stamp detector configured to detect a time stamp added to a TS packet of the TTS inputted by the input unit; a PCR detector configured to detect PCR of the TTS; a time stamp correction value calculator configured to calculate a correction value of a time stamp value for synchronizing a value between the PCR and the time stamp using an output of the time stamp detector and an output of the PCR detector; and a rewriter configured to rewrite the time stamp included in the TTS using the correction value, and outputting a TTS having a corrected time stamp.

According to the foregoing embodiment, TTS having time stamp non-synchronous with PCR is reproducible using a single clock oscillator. Therefore, the receiver is provided at low cost.

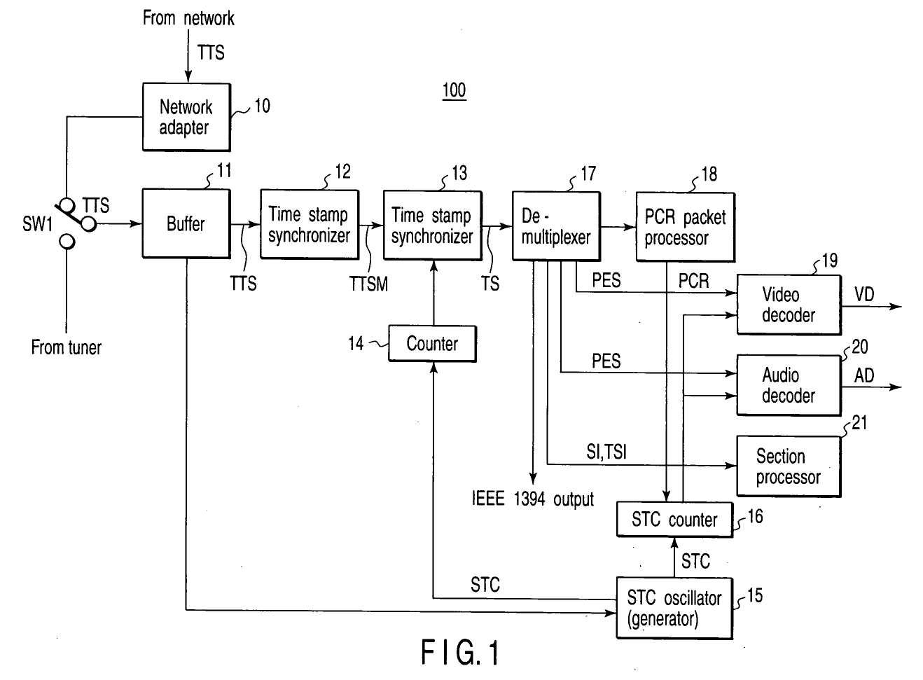

FIG. 1 is a block diagram showing the configuration of a digital broadcasting receiver 100 according to a first embodiment of the present invention. The digital broadcasting receiver 100 is applied to a video reproducing apparatus such as TV and DVD recorder, which receives and reproduces digital broadcasting.

A network adapter 10 realizes an interface with Internet or communication network such as household LAN. A TTS is received from a server on a network by the network adapter 10, and then, inputted to a buffer 11 via a SW1. The TTS is selectively inputted from one of the network adapter 10 and a digital broadcasting tuner (not shown) via the SW1.

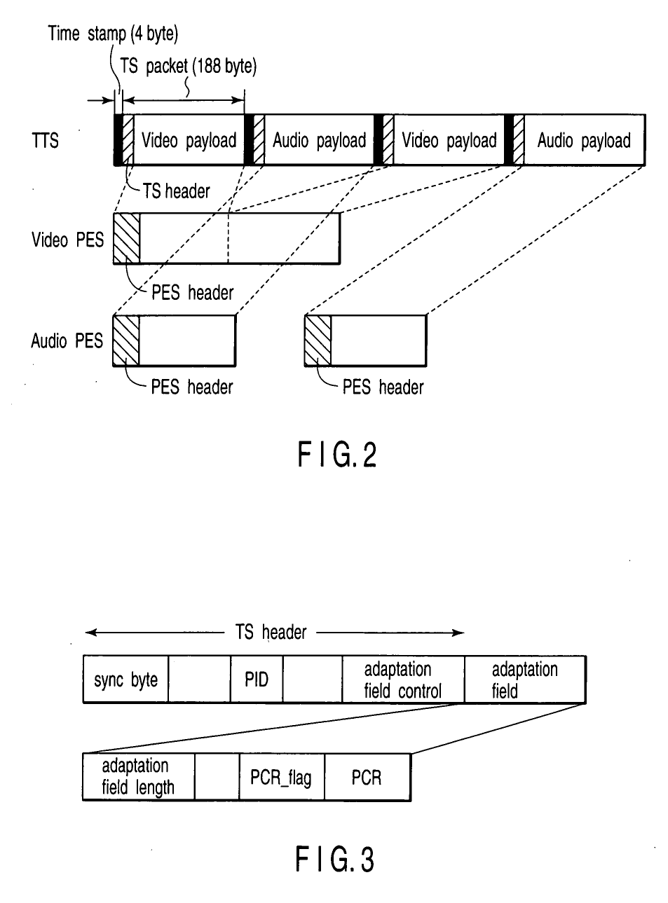

The foregoing TTS will be described hereinafter. FIG. 2 is a view showing the configuration of the TTS. The TTS is configured to add 4-byte time stamp to each 188-byte TS packet forming a TS. The time stamp is information given when the server on the sender side network or digital signal processing apparatus to which the present invention is applied receives each TS packet. The receiving timing of each TS packet is shown there.

Each TS pack is composed of a TS header and payload. The payload is stored with divided video PES or audio PES. The payload is an MPEG2 coded stream.

FIG. 3 is a view showing the structure of the TS header. Sync byte is a code (0×47) showing the header of the TS packet. PID is a packet ID. The video PES and the audio PES each have a uniquely determined different PID value. A de-multiplexer 17 described later checks the PID, and thereby, distinguishes video and audio PES. Adaptation field control is a flag showing whether adaptation field and payload exit in the (TS) packet. Adaptation field length is a value showing the length of the adaptation field. PCR_flag is a flag showing whether or not PCR exists in the packet. The PCR is time information added when the TS packet is created, and used to calibrate receiver time (STC counter 14 described later). The TS packet including the PCR calls a PCR packet. The PCR packet is included in the TS one or more per 100 mS, for example. If this is given as an example of a video frame, for example, one or more PCR packet is included in 3-frame TS.

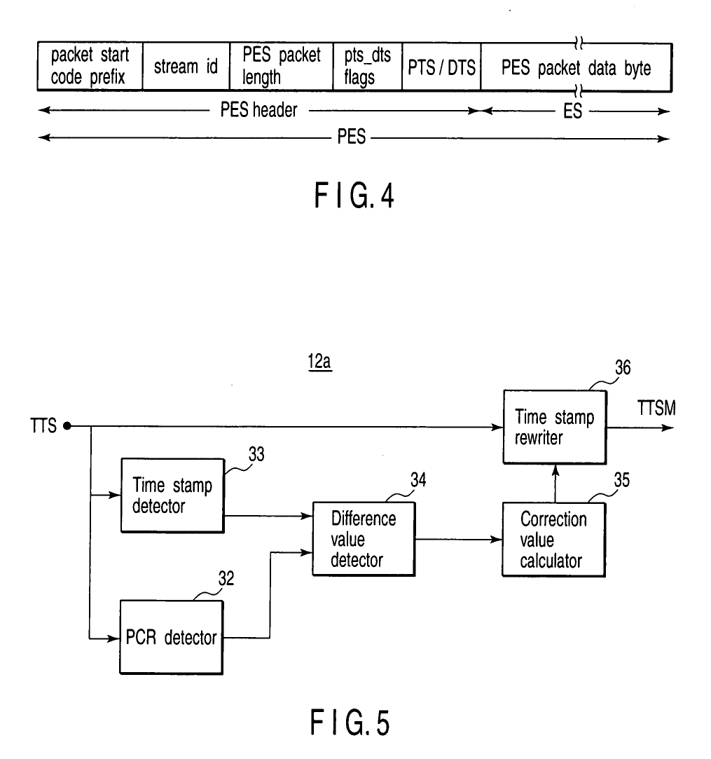

FIG. 4 is a view showing the structure of the PES. The PES structure is the same both in video PES and in audio PES. The PES is composed of a header calling a PES header and PES packet data byte, that is, elementary stream (ES). The ES is data compressing and coded video or audio. A packet start code prefix stored in the PES header is a code (0×000001) showing the header of the PES. A stream id is a value showing the kind of stream. A PES packet length is a value showing the length of the PES. A decoding time stamp (DTS) is time information decoding the PES. A presentation time stamp (PTS) is time information for outputting the decoded data. Video and audio outputted from video and audio decoders 19 and 20 are outputted at time shown by the PTS, and thereby, video and audio are synchronous with each other.

Referring now to FIG. 1, the time stamp synchronizer according to this embodiment of the present invention rewrites the time stamp added to the TS packet into a value synchronous with the PCR. As described before, the time stamp is time information when the receiver receives digital broadcasting issues is to each packet. Namely, the time stamp and PCR are time information generated based on mutually different frequency clock. Thus, TS time stamp clock and the PCR clock are generated using independent oscillator in general. According to the present invention, the time stamp value is rewritten into a value synchronous with the PCR value. By doing so, processing based on time stamp and PCR is carried out using the same oscillator. In this case, synchronizing time stamp with PCR means that the time stamp value is equal to the PCR value or they increase at the same increase rate.

The TTS having time stamp rewritten by the time stamp synchronizer 12 is supplied as TTSM to a time stamp synchronizing transfer 13. The time stamp synchronizing transfer 13 controls TS send timing based on the time stamp, and then, outputs TS only in real time except the time stamp. A counter 14 counts a clock STC (system time clock) generated by an STC oscillator (VCXO) 15. When the time stamp value coincides with the value of the counter 14, the time stamp synchronizing transfer 13 sends the TS packet. The TS packet sent from the time stamp synchronizing transfer 13 is supplied to the de-multiplexer 17.

The de-multiplexer 17 separates PES into video packetized elementary stream (PES) and audio PES from TS. The de-multiplexer 17 supplies the video PES to a video decoder 19 while supplying audio PES to an audio decoder 20. Moreover, the de-multiplexer 17 separates PCR packet from TS, and supplies I to a PCR packet processor 18.

The de-multiplexer 17 separates SI information and TSI information from the TS, and thereafter, supplies them to a section processor 21. The section processor 21 creates an electronic program table and the like from ST information and TSI information. The de-multiplexer 17 converts TS having time stamp synchronous with PCR into IEEE 1394 standard data, and then, outputs it.

The PCR packet processor extracts PCR from the PCR packet, and thereafter, supplies it to an STC counter 16. The STC counter 16 counts STC generated by the STC oscillator 15, and makes correspondence of the PCR supplied from the PCR packet processor 18 and the current count value. The frequency of the STC oscillator is controlled based on data occupation of the buffer 11. Specifically, the frequency of the STC oscillator is controlled so that an input rate of the buffer coincides with an output rate of the time stamp synchronizing transfer 13.

The video decoder 19 compares PTS or DTS of the PES header of the video PES with a value of the STC counter 16. The video decoder 19 decodes the video PES when the DTS coincides with the value of the STC counter 16. Moreover, the video decoder 19 outputs decoded vide data VD when the PTS coincides with the value of the STC counter 16.

The audio decoder 20 compares PTS or DTS of the PES header of the audio PES with a value of the STC counter 16. The audio decoder 20 decodes the audio PES when the DTS coincides with the value of the STC counter 16. Moreover, the audio decoder 20 outputs decoded audio data AD when the PTS coincides with the value of the STC counter 16.

The video data VD is supplied to a display such as LCD via D/A converter and signal amplifier (not shown). Likewise, the audio data is supplied to a speaker via D/A converter and signal amplifier (not shown), and then, audio (sound) is generated.

Time stamp synchronizer 12, time stamp synchronizing transfer 13, de-multiplexer 17, PCR packet processor 18, decoders 19, 20 and section processor 21 may be configured as hardware using independent electronic circuits. Moreover, the foregoing components may be configured as a program processing step such as software.

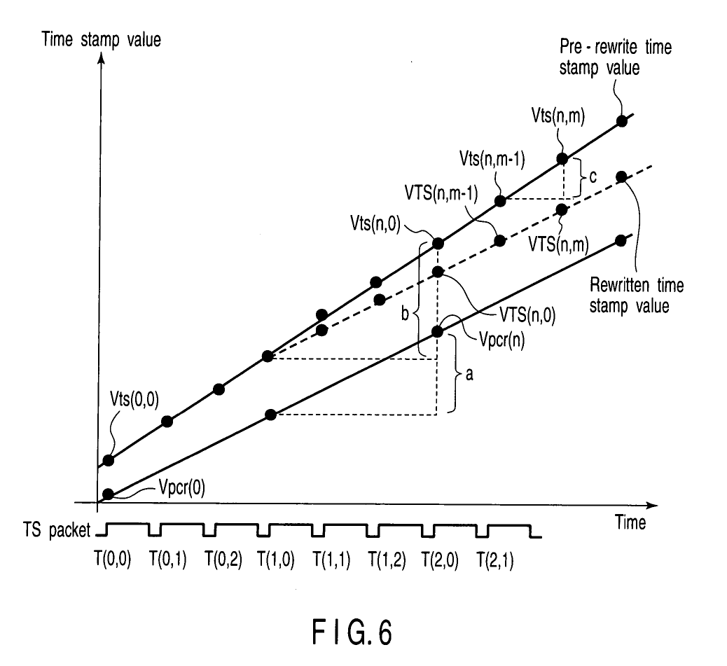

FIG. 5 is a block diagram showing the configuration of a time stamp synchronizer 12a according to a first example of the time stamp synchronizer 12 shown in FIG. 1. The time stamp synchronizer 12a includes PCR detector 32, time stamp detector 33, difference value detector 34, correction value calculator 35 and time stamp rewriter 36. FIG. 6 is a graph to explain the operation of the time stamp synchronizer 12a.

The time stamp detector 33 detects a time stamp added to the TS packet in the inputted TTS. The PCR detector 32 detects PCR recorded in the PCR packet in the inputted TTS.

The first operation of the time stamp synchronizer 12a will be explained hereinafter.

Here, a PCR packet number is given as n (n=0, 1, 2 . . . ), and a TS packet number is given as m (m=0, 1, 2 . . . ). The TS packet number m increases one by one every packet except PCR packet, and is a value returned to 0 when reaching the PCR packet. Moreover, a time stamp value in time T (n, m) is given as Vts (n, m), and a PCR value in time T (n, 0) is given as Vpcr (n).

As seen from FIG. 6, the time stamp is intactly given; that is, is not corrected by time T (1, 0) of the second PCR packet. The difference value detector 34 detects difference values a, b and c using the following equations with respect to a TS packet having no PCR after the time (1, 0).
a=Vpcr(n)−Vpcr(n−1)
b=Vts(n, 0)−Vts(n−1, 0)
c=Vts(n, m)−Vts(n, M−1)

The time stamp rewriter 36 calculates a rewritten time stamp value VTS (n, m) from the following equation using rewritten time stamp value VTS (n, m−1)
VTS(n, m)=VTS(n, m−1)+c*a/b

The correction value calculator 35 calculates a rewritten time stamp value VTS (n, 0) after the time (2, 0) of the third PCR packet using the following equation after calculating the foregoing value a.
VTS(n, 0)=VTS(n−1, 0)+a

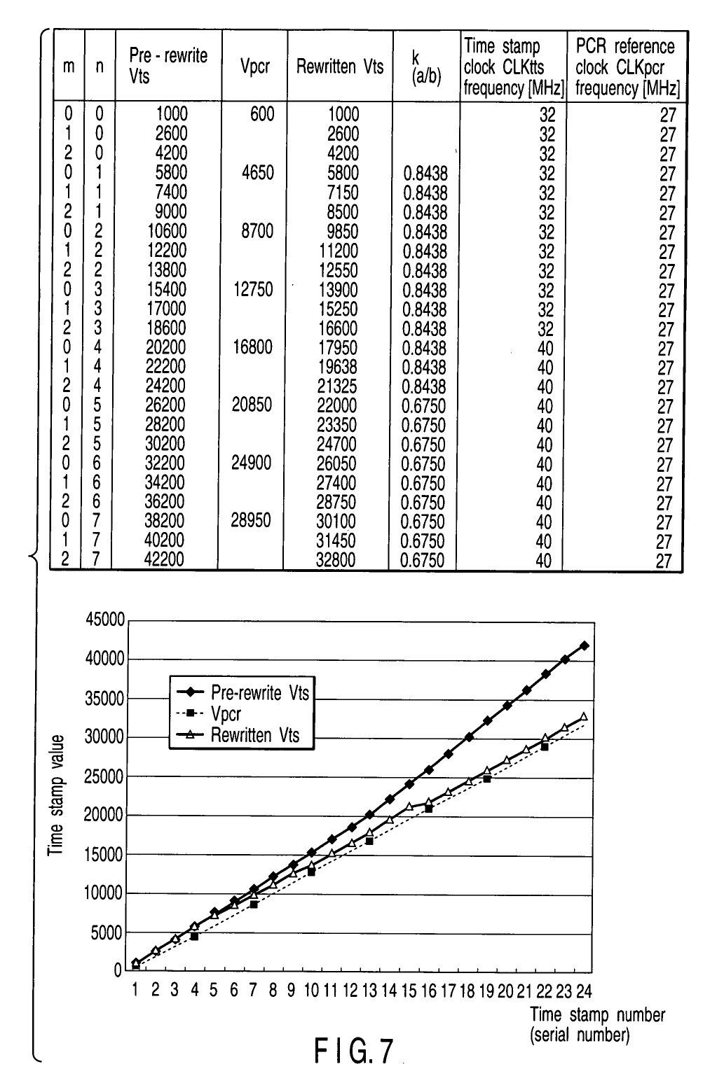

FIG. 7 shows an example of pre-rewrite and rewritten time stamps when the time stamp clock CLKtts of the sender recording time stamp of TTS is 32 MHz and the frequency of PCR clock CLKpcr of apparatus (creating TS) recording PCR of TTS is 27 MHz.

In order to more understand the time stamp, simulation is carried out using the following value, and then, the results are shown there. A value extremely different from the frequency 27 MHz of a PCR counter clock CLKpcr is employed as a frequency of a time stamp counter clock CLKtts. The frequency of a time stamp counter clock CLKtts is 32 MHz when the PCR number n is less than 3, and 40 MHz is used when it is more than 4. If the frequency varies as described above, it can be seen that the inclination of the graph showing PCR is substantially equal to that of the graph showing the rewritten time stamp.

Referring again to FIG. 6, the second operation of the time stamp synchronizer 12a will be explained below.

Like the first operation of the time stamp synchronizer 12a, a PCR packet number is given as n (n=0, 1, 2 . . . ), and a TS packet number is given as m (m=0, 1, 2 . . . ). The TS packet number m increases one by one every packet except PCR packet, and is a value returned to 0 when reaching the PCR packet. Moreover, a time stamp value in time T (n, m) is given as Vts (n, m), and a PCR value in time T (n, 0) is given as Vpcr (n).

As seen from FIG. 6, the time stamp is intactly given by the time (1, 0) of the second PCR packet; namely, no correction is made. The difference value detector 34 calculates difference values a, b and error from the following equations with respect to packet after the time (1, 0)
a=Vpcr(n)−Vpcr(n−1)
b=Vts(n, 0)−Vts(n−1, 0)
Error=a−b

The correction value calculator 35 calculates a correction d from the following equation.
d=(error/PKN)*α

Where, PKN is the number of TS packets existing between PCRs, and the number is 3 in this example. A coefficient a usually takes 0 to 1.

The difference value detector 34 calculates the difference c from the following equation.
c=Vts(n, m)−Vts(n, m−1)

The time stamp rewriter 36 calculates a rewritten time stamp value VTS (n, m) from the following equation using rewritten time stamp value VTS (n, m−1).
VTS(n, m)=VTS(n, m−1)+c+correction d

The correction value calculator 35 calculates a rewritten time stamp value VTS (n, 0) after the time (2, 0) of the third PCR packet using the following equation after calculating the foregoing value a.
VTS(n, 0)=VTS(n−1, 0)+a

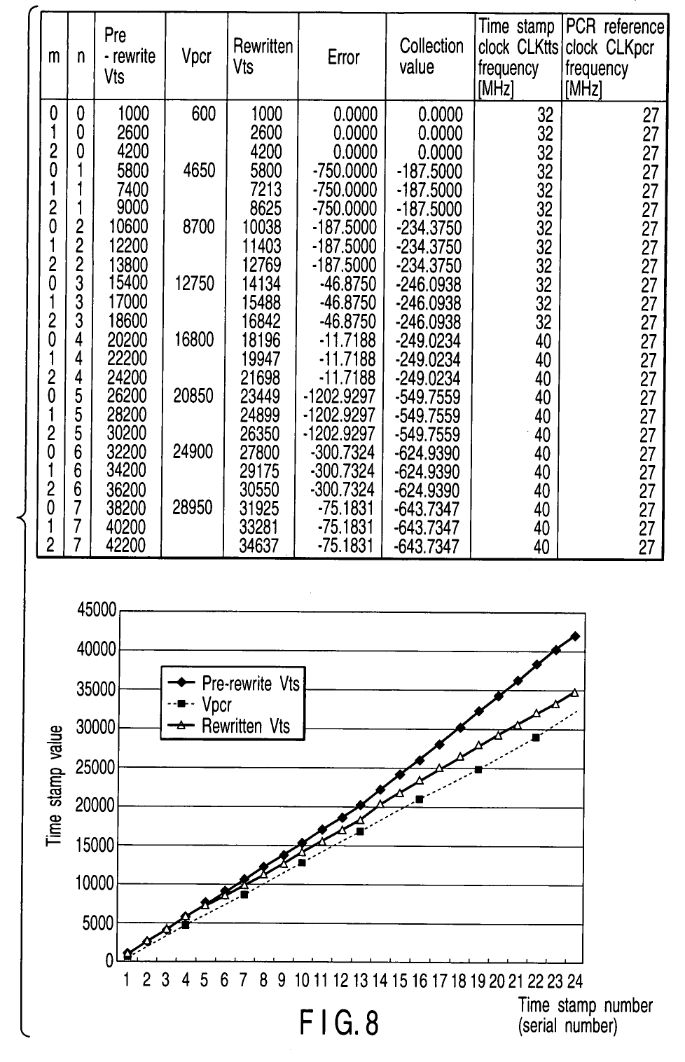

FIG. 8 shows pre-rewrite and rewritten time stamps when the time stamp is rewritten according to the second operation of the time stamp synchronizer 12a. Like FIG. 7, the time stamp clock frequency CLKtts is 32 MHz, and the PCR clock frequency CLKpcr is 27 MHz.

In also case, the time stamp clock frequency CLKtts is 32 MHz when the PCR number is less than 3, and 40 MHz is given when it is more than 4. Even if the frequency varies, it can be seen that the inclination of the graph showing the PCR is substantially equal to that of the graph showing the time stamp value.

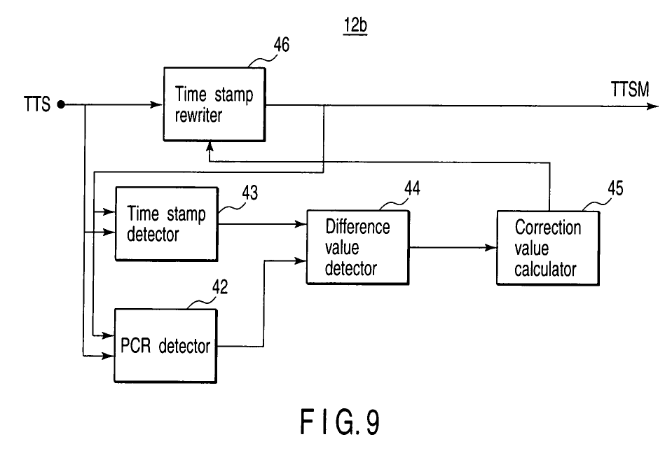

FIG. 9 is a block diagram showing the configuration of a time stamp synchronizer 12b according to a second example of the time stamp synchronizer 12 shown in FIG. 1. The time stamp synchronizer 12b includes PCR detector 42, time stamp detector 43, difference value detector 44, correction value calculator 45 and time stamp rewriter 46.

The time stamp synchronizer 12b has the following configuration. Specifically, a TTSM having time stamp rewritten by the time stamp rewriter 46 is fed back to PCR detector 42 and time stamp detector 43.

The time stamp detector 43 detects time stamp added to each TS of TTS and TTSM, and thereafter, outputs it to the difference value detector 44. The PCR detector 42 extracts a PCR packet of TTS and TTSM to detect PCR in the PCR packet, and then, outputs it to the difference value detector 44.

The difference value detector 44 detects the difference of time stamp values added to the TS packet between TTS and TTSM and the difference of PCR values recorded in the PCR packet between TTS and TTSM. Then, the detector 44 outputs them to the correction value calculator 45. The correction value calculator 45 calculates a time stamp correction value based on the difference between time stamp values and the difference between PCR values. Then, the calculator 45 outputs the calculated time stamp correction value to the time stamp rewriter 46. The time stamp rewriter 46 rewrites time stamp added to the TS packet of the TTS in accordance with the correction value from the correction value calculator 45.

When the time stamp is rewritten, the time stamp value is suddenly changed, for example, the rewritten time stamp value may become smaller than the time stamp value of the preceding TS packet. For this reason, there is problem that the operation of the after-stage time stamp synchronizing transfer 13 becomes unstable. In order to solve the problem, according to this embodiment, the correction value calculated by the correction value calculator 45 is limited to a proper value. By doing so, the time stamp value gradually changes; therefore, the foregoing unstable operation is prevented.

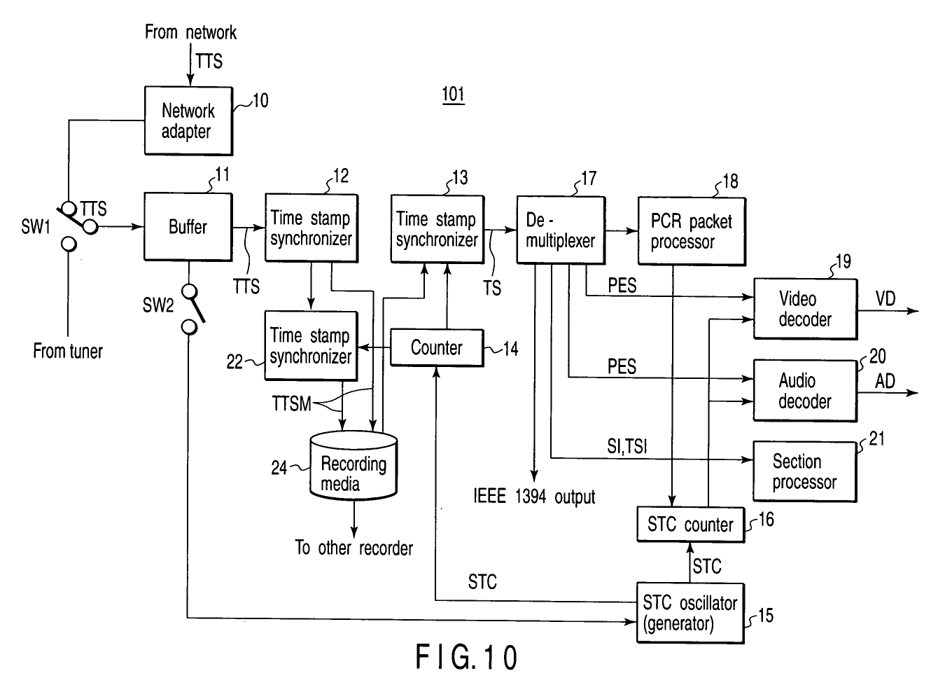

FIG. 10 is a block diagram showing the configuration of a digital signal processing apparatus according to a second embodiment of the present invention.

A digital signal processing apparatus 101 differs from the digital signal processing apparatus 100 shown in FIG. 1 in the following point. Specifically, the digital signal processing apparatus 101 is additionally provided with time stamp synchronizing transfer 22, recording media 24 such as HDD and switch SW2. The same reference numerals are used to designate components identical to the digital signal processing apparatus 100 shown in FIG. 1. Here, the details of these identical components are omitted.

The digital signal processing apparatus 101 records content received via Internet or communication network such as household LAN in the recording media 24. The content output destination is an outside recorder or apparatus having a display transmission function. In this case, the time stamp added to a TS packet of TTS including the content is rewritten as a value synchronous with PCR of the TTS, and then, recorded. In this case, recording is two ways; specifically, one is real time recording made while user is viewing the recorded content. Another is non-real time recording making recording only.

Non-real time recording will be explained below. In this case, the switch SW2 is turned off, and then, the TTS received from network is recorded in the recording media 24 via buffer 11 and time stamp synchronizer 12. The output from the time stamp synchronizer 12 may be outputted to outside devices capable of recording/reproducing via a line such as network. According to the non-real time recording, if a data transfer rate on network and processing speed of the apparatus is sufficiently high, the following advantage is given. Namely, content having one-hour reproducing time is recordable for several minutes.

Real time recording will be explained below. In this case, the switch SW2 is turned on, and then, the TTS received from network is recorded as TTSM in the recording media 24 via buffer 11, time stamp synchronizer 12 and time stamp synchronizing transfer 22. Then, the recorded TTS is supplied to decoders 19 and 20 via time stamp synchronizing transfer 13 and de-multiplexer 17.

In this case, time stamp synchronizing transfers 13 and 22 outputs a TS packet while comparing a value of the counter 14 with the time stamp (synchronous with PCR) of the TS packet. The data output rate at that time is a rate corresponding to 30 frame/second of video. Thus, the content is not transferred at high speed unlike non-real time recording. The TTS of the content is always buffered in the buffer 11, and thereafter, supplied to the time stamp synchronizing transfer 22 (via the time stamp synchronizer 12). In this case, occupation data of the buffer 11 is supplied to the STC oscillator 15 via the switch SW2. In accordance with the occupation data, an oscillation frequency of the STC oscillator 15 is controlled. In this manner, the STC oscillator 15 oscillates at a proper frequency.

Recently, a recorder capable of recording a high-vision video signal with high-vision quality has been developed. In order to record TS in the foregoing recorder, a time stamp synchronous with PCR of TS is added to each TS. The TTS recorded by the digital signal processing apparatus 101 of the present invention satisfies the foregoing standard. Therefore, the content (TTS) is directly dubbed in a disk using the recorder. Moreover, during dubbing, TTS is transfer from the recording media 24 to a disk in non-real time; therefore, high-speed dubbing is possible.

As described above, according to the embodiments of the present invention, one VCXO only is used to reproduce TTS; therefore, the receiver is provided at low cost. Moreover, if time stamp synchronous with PCR is required as recorded data, there is no need of rewriting the time stamp when user records a stream recorded in the HDD in an HDDVD. Therefore, high-speed dubbing is easy.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital signal processing apparatus comprising:
an input unit configured to input a TTS having a time stamp added to a TS of a digital signal from the outside;
a time stamp detector configured to detect a time stamp added to a TS packet of the TTS inputted by the input unit;
a PCR detector configured to detect PCR of the TTS;
a time stamp correction value calculator configured to calculate a correction value of a time stamp value for synchronizing a value between the PCR and the time stamp using an output of the time stamp detector and an output of the PCR detector; and
a rewriter configured to rewrite the time stamp included in the TTS using the correction value, and outputting a TTS having a corrected time stamp.

2. The apparatus according to claim 1, wherein the input unit includes an interface configured to control interface with a communication network, and inputs the TTS from a server on the communication network via the interface.

3. The apparatus according to claim 1, wherein the time stamp correction value calculator includes:
a difference value detector configured to detect the difference of time stamp values detected by the time stamp detector as a first difference, and detect the difference of PCR values detected by the PCR detector as a second difference; and
a calculator configured to calculate a correction value of the time stamp value based on the first and second differences detected by the difference value detector.

4. The apparatus according to claim 1, further comprising:
a recording unit configured to record a TTS having the corrected time stamp outputted from the rewriter in a recording medium.

5. A data stream processing method comprising:
inputting a TTS having a time stamp added to a TS of a digital signal from the outside;
detecting a time stamp added to a TS packet of the inputted TTS;
detecting PCR of the TTS;
calculating a correction value of a time stamp value for synchronizing a value between the PCR and the time stamp using the detected time stamp and the detected PCR; and
rewriting the time stamp included in the TTS using the correction value, and outputting a TTS having a corrected time stamp.

6. The method according to claim 5, wherein the inputting the TTS includes making a communication with a server on a communication network to input the TTS from the server.

7. The method according to claim 5, wherein the calculating the correction value includes:
detecting the difference between the detected time stamp values as a first difference;
detecting the difference between the detected PCR values as a second difference; and
calculating a correction value of the time stamp value based on the detected first and second differences.

8. The method according to claim 5, further comprising:
recording a TTS having the corrected time stamp in a recording medium.
